(19) United States
(12) Patent Application Publication
(10) Pub. No.: US 2008/0152006 A1
(43) Pub. Date: Jun. 26, 2008

(54) REFERENCE FRAME PLACEMENT IN THE ENHANCEMENT LAYER

(75) Inventors: Peisong Chen, San Diego, CA (US); Scott T. Swazey, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 11/771,835

(22) Filed: Jun. 29, 2007

Related U.S. Application Data
(60) Provisional application No. 60/871,655, filed on Dec. 22, 2006.
(60) Provisional application No. 60/892,356, filed on Mar. 1, 2007.

(51) Int. Cl. H04N 7/12

(52) U.S. Cl. 375/240.13

(57) ABSTRACT

The disclosure relates to techniques for allocating the frames of data between the base layer and one or more enhancement layers. The techniques described herein allow for selective placement of frames between the base layer and the enhancement layer to make better use of unused bandwidth in the enhancement layer. In certain aspects, an encoding device may allocate a reference frame temporally located immediately prior to an intra-coded frame to the enhancement layer. In other aspects, the encoding device may allocate a reference frame that is located at the end of a segment of data that includes a plurality of frames, e.g., a superframe, to the enhancement layer. The described techniques may be utilized to help balance bandwidth between the base layer and the one or more enhancement layers.

### TECHNICAL FIELD

This application claims the benefit of U.S. Provisional Application No. 60/871,655, filed on Dec. 22, 2006 and U.S. Provisional Application No. 60/892,356 filed Mar. 1, 2007. The entire content of each of these applications is incorporated herein by reference.

### TECHNICAL FIELD

The disclosure relates to multimedia coding and communication of coded multimedia content.

### BACKGROUND

Digital multimedia capabilities can be incorporated into a wide range of devices, including digital televisions, digital direct broadcast systems, wireless communication devices, wireless broadcast systems, personal digital assistants (PDAs), laptop or desktop computers, digital cameras, digital recording devices, video gaming devices, video game consoles, cellular or satellite radio telephones, and the like. Digital multimedia devices may implement coding techniques, such as MPEG-2, MPEG-4, or H.264/MPEG-4, Part 10, Advanced Video Coding (AVC), to transmit and receive digital video data more efficiently. These coding techniques may perform compression via spatial and temporal prediction to reduce or remove redundancy in multimedia sequences.

Some video coding makes use of scalable techniques. For example, scalable video coding (SVC) refers to coding in which a base layer and one or more scalable enhancement layers are used. For SVC, a base layer typically carries multimedia data with a base level of quality. One or more enhancement layers carry additional multimedia data to support higher spatial, temporal and/or signal-to-noise ratio (SNR) levels. As an example, the base layer may be transmitted in a manner that is more reliable than the transmission of enhancement layers. Enhancement layers may add spatial resolution to frames of the base layer, add additional frames to increase the overall frame rate, or add additional bits to improve signal-to-noise ratio. In one example, the most reliable portions of a modulated signal may be used to transmit the base layer, while less reliable portions of the modulated signal may be used to transmit the enhancement layers.

SVC may be used in a wide variety of coding applications. One particular area where SVC techniques are commonly used is in wireless multimedia broadcast applications. Examples of multimedia broadcasting techniques include those referred to as Forward Link Only (FLO), Digital Multimedia Broadcasting (DMB), and Digital Video Broadcasting-Handheld (DVB-H).

### SUMMARY

In certain aspects of this disclosure, a method for processing multimedia data comprises coding a plurality of frames of multimedia data, wherein the plurality of frames include one or more reference frames and allocating each of the plurality of frames between a base layer bitstream and at least one enhancement layer bitstream such that at least one of the one or more reference frames is allocated to the enhancement layer bitstream.

In certain aspects of this disclosure, an apparatus for processing multimedia data comprises an encoding module that codes a plurality of frames of multimedia data, wherein the plurality of frames include one or more reference frames and an allocation module that allocates each of the plurality frames between a base layer bitstream and at least one enhancement layer bitstream such that at least one of the one or more reference frames is allocated to the enhancement layer bitstream.

In certain aspects of this disclosure, an apparatus for processing multimedia data comprises means for coding a plurality of frames of multimedia data, wherein the plurality of frames include one or more reference frames and means for allocating each of the plurality of frames between a base layer bitstream and at least one enhancement layer bitstream such that at least one of the one or more reference frames is allocated to the enhancement layer bitstream.

In certain aspects of this disclosure, a computer-program product for processing multimedia data comprises a computer readable medium having instructions thereon. The instructions comprise code for encoding a plurality of frames of multimedia data, wherein the plurality of frames include one or more reference frames and code for allocating each of the plurality of frames between a base layer bitstream and at least one enhancement layer bitstream such that at least one of the one or more reference frames is allocated to the enhancement layer bitstream.

In certain aspects of this disclosure, a method for processing multimedia data comprises identifying at least one frame of a base layer bitstream of a scalable coding scheme that references at least a portion of a reference frame of an enhancement layer bitstream and decoding the identified frame of the base layer bitstream using the portion of the reference frame of the enhancement layer bitstream referenced by the identified frame of the base layer bitstream when the enhancement layer bitstream is received.

In certain aspects of this disclosure, an apparatus for processing multimedia data comprises a reference data analysis module that identifies at least one frame of a base layer bitstream of a scalable coding scheme that references at least a portion of a reference frame of an enhancement layer bitstream and a decoding module that decodes the identified frame of the base layer bitstream using the portion of the reference frame of the enhancement layer bitstream referenced by the identified frame of the base layer bitstream when the enhancement layer bitstream is received.

In certain aspects of this disclosure, an apparatus for processing multimedia data comprises means for identifying at least one frame of a base layer bitstream of a scalable coding scheme that references at least a portion of a reference frame of an enhancement layer bitstream and means for decoding the identified frame of the base layer bitstream using the portion of the reference frame of the enhancement layer bitstream referenced by the identified frame of the base layer bitstream when the enhancement layer bitstream is received.

In certain aspects of this disclosure, a computer-program product for processing multimedia data comprises a computer readable medium having instructions thereon. The instructions comprise code for identifying at least one frame of a base layer bitstream of a scalable coding scheme that references at least a portion of a reference frame of an enhancement layer bitstream and code for decoding the identified frame of the base layer bitstream using the portion of the reference frame of the enhancement layer bitstream referenced by the identified frame of the base layer bitstream when the enhancement layer bitstream is received.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example multimedia coding system that supports coding scalability.

FIG. 2 is a block diagram illustrating an example encoding device forming part of the system of FIG. 1.

FIG. 3 is a block diagram illustrating an example decoding device forming part of the system of FIG. 1.

FIG. 4 is a diagram illustrating a portion of an example encoded multimedia sequence in which a reference frame immediately prior to an intra-frame is placed in an enhancement layer bitstream.

FIG. 5 is a diagram illustrating a portion of another example encoded multimedia sequence in which a reference frame immediately prior to a channel switch frame is placed in an enhancement layer bitstream.

FIG. 6 is a diagram illustrating a portion of another example encoded multimedia sequence in which a reference frame located at the end of a segment of data is placed in an enhancement layer bitstream.

FIG. 7 is a flow diagram illustrating exemplary operation of an encoding device in allocating one or more reference frames in accordance with the techniques of this disclosure.

FIG. 8 is a flow diagram illustrating exemplary operation of a decoding device in selectively decoding frames of a base layer.

### DETAILED DESCRIPTION

The disclosure describes techniques for allocating frames of data of a multimedia sequence between at least two layers in a scalable coding scheme, such as scalable video coding (SVC). In SVC, a coded multimedia sequence includes a base layer and one or more enhancement layers. For purposes of illustration, the techniques of this disclosure will be described with reference to a base layer and only one enhancement layer. It should be apparent to one skilled in the art, however, that the techniques may be extended to SVC schemes that utilize more than one enhancement layer.

The base layer refers to a bitstream that carries a minimum amount of data for multimedia decoding, and provides a base level of quality. The enhancement layer refers to a bitstream that carries additional data that enhances the quality of the decoded multimedia. In general, the enhancement layer bitstream is only decodable in conjunction with the base layer, i.e., the frames of the enhancement layer contain references to one or more frames of the decoded base layer. However, in other aspects, the enhancement layer may be at least partially decoded without a base layer.

Using hierarchical modulation, the base layer and enhancement layer can be transmitted on the same carrier or subcarriers but with different transmission characteristics resulting in different reliability. In other words, the base layer is transmitted via more reliable portions of a modulated signal, while the enhancement layer is transmitted via less reliable portions of the modulated signal. For example, the base layer and enhancement layer may be transmitted with different packet error rates (PERs). In particular, the base layer may be transmitted at a lower PER for more reliable reception throughout a coverage area while the enhancement layer is transmitted at a higher PER. In this manner, the bitstream that carries the data for decoding the base layer has more reliable reception, allowing a user to view the content of the multimedia sequence, albeit at a lower level of quality, in areas that otherwise would not provide reception.

A decoding device may decode only the base layer in cases in which the enhancement layer is not received. Otherwise, when both the base layer and the enhancement layer are received, the decoding device may decode the base layer plus the enhancement layer to provide higher quality.

This disclosure proposes techniques for allocating the frames of data between the base layer and one or more enhancement layers. The techniques described herein allow for selective placement of frames between the base layer and the enhancement layer to make better use of unused bandwidth in the enhancement layer. In certain aspects, an encoding device may allocate a reference frame temporally located prior to and near an intra-coded frame to the enhancement layer. Since intra-coded frames are coded without reference to any other temporally located frames, moving the reference frame temporally located prior to and near the intra-coded frame does not affect the decoding of the subsequent frame.

In other aspects, the encoding device may allocate a reference frame that is located near an end of a segment of data that includes a plurality of frames, e.g., a superframe, to the enhancement layer. In this case, references of frames in the base layer to the reference frame moved to the enhancement layer may be eliminated to reduce the effect on the decoding of the subsequent frames. Alternatively, references of frames in the base layer to the reference frame moved to the enhancement layer may remain, and the decoding device may selectively decode the received frames based on whether the enhancement layer was received. The described techniques may be utilized to help balance bandwidth between the base layer and the one or more enhancement layers.

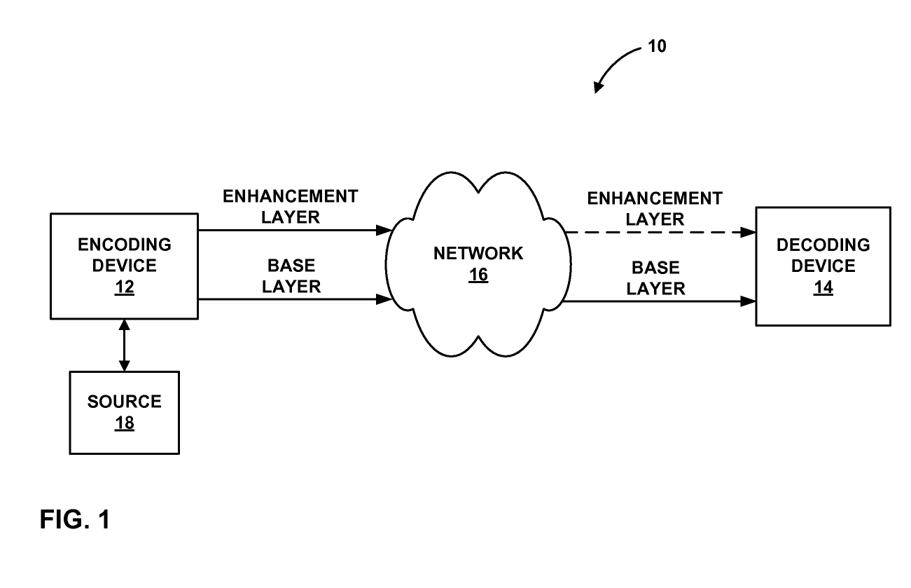

FIG. 1 is a block diagram illustrating an exemplary multimedia coding system 10 that supports video scalability. Multimedia coding system 10 includes an encoding device 12 and a decoding device 14 connected by a network 16. Encoding device 12 obtains digital multimedia sequences from at least one source 18, encodes the digital multimedia sequences and transmits the coded sequences over network 16 to decoding device 14.

In certain aspects, source 18 may comprise one or more video content providers that broadcast digital multimedia sequences, e.g., via satellite. In other aspects, source 18 may comprise an image capture device that captures the digital multimedia sequence. In this case, the image capture device may be integrated within encoding device 12 or coupled to encoding device 12. Although source 18 is illustrated in FIG. 1 as an external source, in certain embodiments, encoding device 12 may receive the multimedia sequences from a memory or archive within encoding device 12 or coupled to encoding device 12.

The multimedia sequences may comprise live real-time or near real-time video and/or audio sequences to be coded and transmitted as a broadcast or on-demand, or may comprise pre-recorded and stored video and/or audio sequences to be coded and transmitted as a broadcast or on-demand. In some aspects, at least a portion of the multimedia sequences may be computer-generated, such as in the case of gaming.

The digital multimedia sequences received from source 18 may be described in terms of a sequence of pictures, which include frames (an entire picture) or fields (e.g., fields of alternating odd or even lines of a picture). Further, each frame or field may further include two or more slices, or sub-portions of the frame or field. As used herein, the term “frame” may refer to a picture, a frame, a field or a slice thereof.

Encoding device 12 encodes the multimedia sequences for transmission to decoding device 14. Encoding device 12 may encode the multimedia sequences according to a video compression standard, such as Moving Picture Experts Group (MPEG)-1, MPEG-2, MPEG-4, International Telecommunication Union Standardization Sector (ITU-T) H.263, or ITU-T H.264, which corresponds to MPEG-4, Part 10, Advanced Video Coding (AVC). Such encoding, and by extension, decoding, methods may be directed to lossless or lossy compression algorithms to compress the content of the frames for transmission and/or storage. Compression can be broadly thought of as the process of removing redundancy from the multimedia data.

In some aspects, this disclosure contemplates application to Enhanced H.264 video coding for delivering real-time multimedia services in terrestrial mobile multimedia multicast (TM3) systems using the Forward Link Only (FLO) Air Interface Specification, “Forward Link Only Air Interface Specification for Terrestrial Mobile Multimedia Multicast,” published as Technical Standard TIA-1099, August 2006 (the “FLO Specification”). However, the channel switching techniques described in this disclosure are not limited to any particular type of broadcast, multicast, unicast or point-to-point system.

The H.264/MPEG-4 (AVC) standard was formulated by the ITU-T Video Coding Experts Group (VCEG) together with the ISO/IEC Moving Picture Experts Group (MPEG) as the product of a collective partnership known as the Joint Video Team (JVT). The H.264 standard is described in ITU-T Recommendation H.264, Advanced video coding for generic audiovisual services, by the ITU-T Study Group, and dated March 2005, which may be referred to herein as the H.264 standard or H.264 specification, or the H.264/AVC standard or specification.

The Joint Video Team (JVT) continues to work on a scalable video coding (SVC) extension to H.264/MPEG-4 AVC. The specification of the evolving SVC extension is in the form of a Joint Draft (JD). The Joint Scalable Video Model (JSVM) created by the JVT implements tools for use in scalable video, which may be used within system 10 for various coding tasks described in this disclosure. Detailed information concerning Fine Granularity SNR Scalability (FGS) coding can be found in the Joint Draft documents, e.g., in Joint Draft 6 (SVC JD6), Thomas Wiegand, Gary Sullivan, Julien Reichel, Heiko Schwarz, and Mathias Wien, “Joint Draft 6: Scalable Video Coding,” JVT-S 201, April 2006, Geneva, and in Joint Draft 9 (SVC JD9), Thomas Wiegand, Gary Sullivan, Julien Reichel, Heiko Schwarz, and Mathias Wien, “Joint Draft 9 of SVC Amendment,” JVT-V 201, January 2007, Marrakech, Morocco.

Encoding device 12 encodes each of the frames of the sequences using one or more coding techniques. For example, encoding device 12 may encode one or more of the frames using intra-coding techniques. Frames encoded using intra-coding techniques, often referred to as intra (“I”) frames, are coded without reference to other frames. Frames encoded using intra-coding, however, may use spatial prediction to take advantage of redundancy in other multimedia data located in the same frame.

Encoding device 12 may also encode one or more of the frames using inter-coding techniques. Frames encoded using inter-coding techniques are coded with reference to one or more other frames, referred to herein as reference frames. The inter-coded frames may include one or more predictive (“P”) frames, bi-directional (“B”) frames or a combination thereof. P frames are encoded with reference to at least one temporally prior frame while B frames are encoded with reference to at least one temporally future frame and at least one temporally prior frame. The temporally prior and/or temporally future frames are referred to as “reference frames.” In this manner, inter-coding takes advantage of redundancy in multimedia data across temporal frames.

Encoding device 12 may be further configured to encode a frame of the sequence by partitioning the frame into a plurality of subsets of pixels, and separately encoding each of the subsets of pixels. These subsets of pixels may be referred to as blocks or macroblocks and may include, for example, 16×16 subsets of pixels that include sixteen rows of pixels and sixteen columns of pixels. Encoding device 12 may further partition each block into two or more sub-blocks. As an example, a 16×16 block may comprise four 8×8 sub-blocks, or other sub-partition blocks. For example, the H.264 standard permits encoding of blocks with a variety of different sizes, e.g., 16×16, 16×8, 8×16, 8×8, 4×4, 8×4, and 4×8. Further, by extension, sub-blocks of any size may be included within a block, e.g., 2×16, 16×2, 2×2, 4×16, 8×2 and so on. Blocks of larger than 16 rows or columns are also possible. As used herein, the term “block” may refer to either any size block or sub-block.

Regardless of whether the frames are encoded using intra-coding or inter-coding, each of the frames of the sequence may be characterized as a reference frame or a non-reference frame. As described above, the term “reference frame” refers to a frame that includes multimedia data that is used by encoding device 12 for compression of at least a portion of another one of the frames. In other words, the reference frame is used for successful decoding of the frame that relies on the reference frame. The reference frame may be either an intra-coded frame or an inter-coded frame, i.e., an I frame, B frame or P frame. To the contrary, the term “non-reference frame” refers to a frame that is not used by encoding device 12 for compression of other frames. In other words, no other frames rely on multimedia data from the non-reference frame for successful decoding. Thus, if a non-reference frame is lost in transmission, there would be no effect on the decoding of other frames of the sequence. Like reference frames, non-reference frames can be either intra-coded frame or inter-coded frames. However, typically only P frames and B frames are used as non-reference frames.

To support scalable video, encoding device 12 allocates the encoded frames between a base layer bitstream (referred to herein as “base layer”) and at least one enhancement layer bitstream (referred to herein as “enhancement layer”). As described above, the base layer carries a minimum amount of data for multimedia decoding. As such, the base layer is transmitted via a more reliable portion of a modulated signal, e.g., with a lower PER. The enhancement layer carries additional data that enhances the quality of the decoded multimedia of the base layer. The enhancement layer is transmitted via a less reliable portion of the modulated signal, e.g., with a higher PER. In some cases, the enhancement layer may be only decodable in conjunction with the base layer, i.e., the frames of the enhancement layer contain references to one or more frames of the decoded base layer. However, in other cases, the enhancement layer may be at least partially decoded without a base layer

In some aspects, such as in accordance with the FLO Air Interface Specification, it may be desirable that the size of the base layer and the size of the enhancement layer are substantially the same. In other words, encoding device 12 may transmit substantially the same the number of bits in the enhancement layer as in the base layer. In cases where the initial allocation of frames results in an imbalance between the sizes of the layers, encoding module 12 may reallocate the frames in accordance with the techniques described herein. Reallocation of the frames as described below eliminates the need for encoding module 12 to waste bandwidth sending padding bits, i.e., information added to balance the sizes of the layers but not used by decoding module 14. Although the examples described herein are directed to reallocating the frames from the base layer to the enhancement layer, similar techniques may be utilized for initially allocating the frames from the enhancement layer to the base layer.

The techniques described herein allow for selective placement of frames within the base layer or the enhancement layer to reallocate the frames between the base layer and the enhancement layer. In particular, in some aspects, at least one reference frame may be moved from the base layer to the enhancement layer in order to achieve a better balance of data between the different layers. In certain aspects, encoding device 12 may move a reference frame temporally located prior to and near an intra-coded frame. For example, encoding device 12 may move the reference frame temporally located immediately prior to the intra-coded frame. In other aspects, encoding device 12 may move a reference frame that is located near the end of a segment of data that includes a plurality of frames, e.g., a superframe. The described techniques may help to balance bandwidth between the base layer and the one or more enhancement layers.

Encoding device 12 transmits the encoded sequences over network 16 to decoding device 14 for decoding and presentation to a user of decoding device 14. Network 16 may comprise one or more of a wired or wireless communication networks, including one or more of an Ethernet, telephone (e.g., POTS), cable, power-line, and fiber optic systems, and/or a wireless system comprising one or more of a code division multiple access (CDMA or CDMA2000) communication system, a frequency division multiple access (FDMA) system, an orthogonal frequency division multiple (OFDM) access system, a time division multiple access (TDMA) system such as GSM/GPRS (General packet Radio Service)/EDGE (enhanced data GSM environment), a TETRA (Terrestrial Trunked Radio) mobile telephone system, a wideband code division multiple access (WCDMA) system, a high data rate (1xEV-DO or 1xEV-DO Gold Multicast) system, an IEEE 802.11 system, a FLO system, a digital media broadcast (DMB) system, a digital video broadcast-handheld (DVB-H) system, integrated services digital broadcast-terrestrial (ISDB-T) system and the like.

In certain aspects, encoding device 12 may encode, combine and transmit frames received over a period of time. In some multimedia coding systems, for example, a plurality of frames of multimedia data are grouped together into a segment of multimedia data, sometimes referred to as a “superframe.” As used herein, the term “superframe” refers to a group of frames collected over a time period or window to form a segment of data. In a coding system that utilizes FLO technology, the superframe may comprise a one-second segment of data, which may nominally have 30 frames. A superframe may, however, include any number of frames. The techniques may also be utilized for encoding, combining and transmitting other segments of data, such as for segments of data received over a different period of time, which may or may not be a fixed period of time, or for individual frames or sets of frames of data. In other words, superframes could be defined to cover larger or smaller time intervals than one-second periods, or even variable time intervals. Note that, throughout this disclosure, a particular segment of multimedia data (e.g., similar to the concept of a superframe) refers to any chunk of multimedia data of a particular size and/or duration.

In some aspects, encoding device 12 may form part of a broadcast network component used to broadcast one or more channels of multimedia data. As such, each of the encoded sequences may correspond to a channel of multimedia data. Each of the channels of multimedia data may comprise a base layer and at least one enhancement layer. As an example, encoding device 12 may form part of a wireless base station, server, or any infrastructure node that is used to broadcast one or more channels of encoded multimedia data to wireless devices. In this case, encoding device 12 may transmit the encoded data to a plurality of wireless devices, such as decoding device 14. A single decoding device 14, however, is illustrated in FIG. 1 for simplicity.

Decoding device 14 receives the encoded sequences from network 16 and decodes the coded sequences. Depending on the location of decoding device 14 relative to network 16, decoding device 14 may or may not receive the enhancement layer. In the wireless context, for example, decoding device 14 may receive both the base layer and enhancement layer when decoding device 14 is closer to a transmission tower within network 16. Decoding device 14 may only receive the base layer, however, when it is further away from the transmission tower within network 16. In other words, the base layer is more reliably received by decoding device 14 when it is within an applicable coverage area because the base layer is transmitted at higher power.

In cases in which the enhancement layer is not received, decoding device 14 may decode only the base layer. In this case, decoding device 14 is capable of presenting the content of the multimedia sequence albeit at the minimum quality level provided by the base layer. When both the base layer and the enhancement layer are received, however, decoding device 14 is capable of decoding and combining the data of the base layer and the enhancement layer to present higher quality video. Hence, the video obtained by decoding device 14 is scalable in the sense that the enhancement layer can be decoded and added to the base layer to increase the quality of the decoded video. However, scalability is only possible when the enhancement layer data is present.

Decoding device 14 may, for example, be implemented as part of a digital television, a wireless communication device, a gaming device, a portable digital assistant (PDA), a laptop computer or desktop computer, a digital music and video device, such as those sold under the trademark “iPod,” or a radiotelephone such as cellular, satellite or terrestrial-based radiotelephone, or other wireless mobile terminal equipped for video and/or audio streaming, video telephony, or both. Decoding device 14 may be associated with a mobile or stationary device. In other aspects, decoding device 14 may comprise a wired device coupled to a wired network.

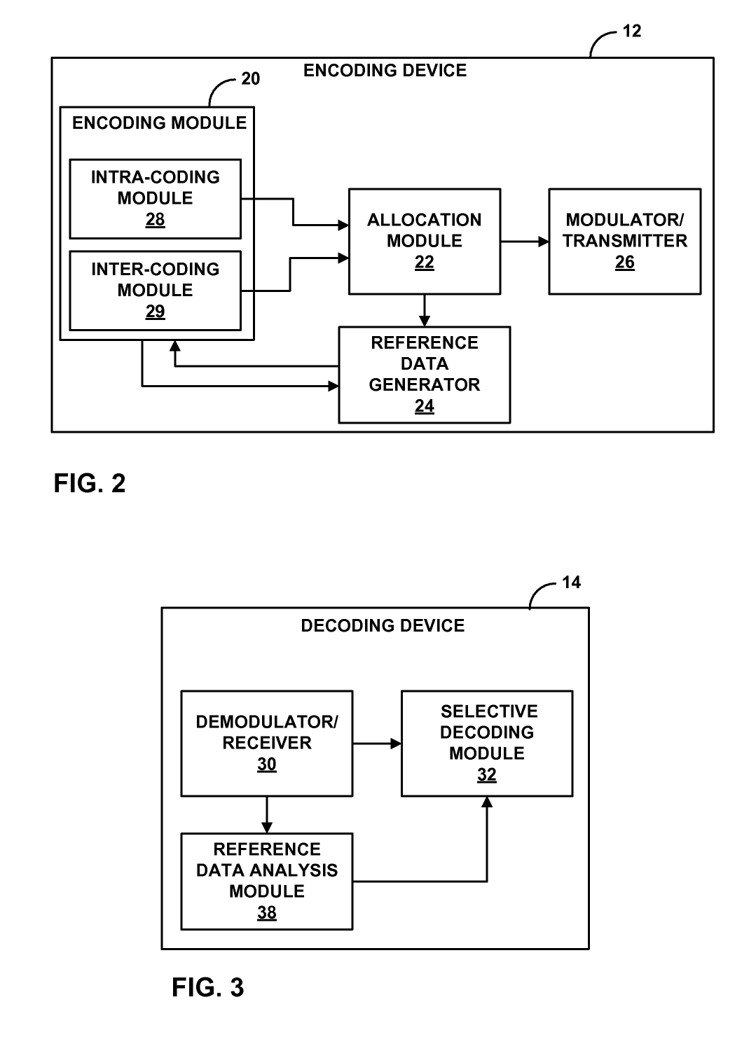

FIG. 2 is a block diagram illustrating encoding device 12 in further detail. As shown in FIG. 2, encoding device 12 includes an encoding module 20, an allocation module 22, a reference data generator 24 and a modulator/transmitter 26. Encoding module 20 includes an intra-coding module 28 and an inter-coding module 29.

Encoding module 20 receives one or more input multimedia sequences from source 18 (FIG. 1) and selectively encodes frames of the received multimedia sequences. In particular, intra-coding module 28 encodes one or more of the frames of the sequence without reference to other frames. Intra-coding module 28 may, for example, encode frames of the sequence as I frames at the start of a video sequence or at a scene change. Alternatively, or additionally, intra-coding module 28 may intra-code frames for intra refresh or for channel switching. As described above, intra-coding module 28 may encode the frames using spatial prediction to take advantage of redundancy in other multimedia data located in the same frame.

Inter-coding module 29 encodes one or more of the frames of the sequence with reference to one or more other temporally located frames, i.e., as I frames, P frames, B frames or a combination thereof. Inter-coding module 29 may take advantage of redundancy in other temporally located frames, i.e., reference frames, such as one or more frames near each other in the temporal sequence of frames. The reference frames may have one or more blocks that are a match or at least a partial match to one or more blocks of the frame to be encoded. In this case, inter-coding module 29 may encode the frame using motion compensated prediction with reference to blocks of data across temporal frames. Specifically, inter-coding module 29 may encode the frame as data that comprises one or more motion vectors and residuals for a particular partitioning of the frame.

Reference data generator 24 may generate reference data that indicates a location of the intra-coded and inter-coded multimedia data generated by the encoding module 20. The reference data generated by reference data generator 24 may, for example, identify whether a frame is an I frame, a P frame, a B frame or other type of frame. Additionally, the reference data may include one or more block identifiers that identify blocks and the type of coding used to code the blocks within the frame. The reference data may also include frame sequence numbers that identify a location of one or more reference frames within the multimedia sequence.

Allocation module 22 allocates the encoded frames between a base layer bitstream and at least one enhancement layer bitstream. In certain aspects, allocation module 22 allocates the frames based on whether the frames are used as reference frames. Allocation module 22 may, for example, initially assign reference frames to the base layer and assign non-reference frames to the enhancement layer. Since B frames are typically not used as reference frames and usually reference a previous and subsequent P frame, such an allocation scheme typically allocates I and P frames to the base layer and B frames to the enhancement layer. However, encoding device 12 may encode I or P frames as non-reference frames and assign the non-reference I or P frames to the enhancement layer. Likewise, encoding device 12 may encode one or more B frames as reference frames and assign the reference B frames to the base layer. Moreover, allocation module 22 may use an initial allocation scheme in which one or more non-reference frames are initially assigned to the base layer. For example, allocation module 22 may initially allocate all I and P frames to the base layer, whether or not the P frames are reference frames or non-reference frames. Moreover, allocation module 22 may further initially allocate one or more non-reference B frames to the base layer.

In certain aspects, such as in accordance with the FLO Air Interface Specification, it may be desired that the base layer and the enhancement layer be substantially the same size. In conventional coding systems, the encoding device may balance the base layer and enhancement layer by incorporating pad bits in the bitstream of the layer that is substantially smaller, i.e., the difference between the number of bits in the base layer and enhancement layer exceeds a predetermined threshold. The padding bits are ignored by the decoder during the decoding process. The techniques described herein allow for selective placement of frames between the base layer and the enhancement layer to make better allocate the bits between the layers.

In particular, allocation module 22 may analyze the allocation of the plurality of frames between the base layer and the enhancement layer and reallocate one or more of the frames between the base layer and enhancement layer. Allocation module 22 attempts to minimize the difference between the size of the base layer and the enhancement layer. For example, if the number of bits in the bitstream (i.e., size) of the base layer is smaller than the number of bits in the bitstream of the enhancement layer by a predetermined margin or threshold, allocation module 22 may reassign one or more of the frames of the enhancement layer to the base layer. Alternatively, encoding module 20 may encode additional frames to include in the base layer. In this manner, allocation module 22 balances the sizes of the base layer and the enhancement layer to make the sizes substantially the same. Encoding module 20 may additionally add padding bits to either the base layer or the enhancement layer to make the layers the same size. However, the smaller the difference between the layers the less bandwidth that is wasted by the padding bits.

If the number of bits of the bitstream (i.e., size) of the enhancement layer is smaller than the number of bits of the base layer by a predetermined margin or threshold, allocation module 22 may reassign one or more of the frames of the base layer to the enhancement layer to make the sizes substantially the same. If there are non-reference frames in the base layer, allocation module 22 may reassign the non-reference frames to the enhancement layer. By moving non-reference frames to the enhancement layer, there is no effect on the decoding of subsequent frames when the enhancement layer is not received by decoding device 14.

If there are no non-reference frames in the base layer, allocation module 22 selects at least one reference frame to move from the base layer to the enhancement layer. In certain aspects, allocation module 22 may move a reference frame that is temporally located prior to and near an intra-coded frame. For example, allocation module 22 may reassign a reference frame that is temporally located immediately prior to an I frame or a channel switch frame (CSF). A CSF ordinarily will be intra-coded to facilitate immediate access to a channel. Since intra-coded frames are coded without reference to any other temporally located frames, moving the reference frame temporally located immediately prior to the intra-coded frame does not affect the decoding of the subsequent frame. Moreover, to the extent the reference frame is referenced by one or more frames in the enhancement layer, the reference frame will be received if the frame in the enhancement layer that relies on the reference frame is received. In other aspects, allocation module 22 may move a reference frame that is temporally located prior to and near the intra-coded frame, e.g., two or three frames prior to the intra-coded frame.

In other aspects, allocation module 22 may move a reference frame located near the end of a superframe or other segment of data. In this case, encoding device 12 may adjust one or more reference data. For example, allocation module 22 may request that encoding module 20 re-encode one or more frames of the base layer that rely on the reassigned reference frame to include a reference to a different frame in the base layer. Alternatively, if the frame that relies on the reassigned frame is coded using multiple reference frames, reference data generator 24 may simply remove the reference to the reference frame that was reassigned to the enhancement layer. Adjusting the reference data may reduce the effect of not receiving the enhancement layer when decoding the subsequent frames of the base layer. In some aspects, however, encoding device 12 may not adjust any reference data, and instead simply leave the references to the reassigned frame. In this case, decoding device 14 may decode the data normally if the enhancement layer with the reference frame is received. If the enhancement layer that includes the reference frame is not received, decoding device 14 may perform error correction to account for the missing data of the reference frame.

After allocating the frames between the base layer and the enhancement layer, encoding device 12 transmits the frames over network 16 (FIG. 1) via modulator/transmitter 26. Modulator/transmitter 26 may include appropriate modem, amplifier, filter, and frequency conversion components to support modulation and wireless transmission of the encoded multimedia sequences over network 16. As described above, modulator/transmitter 26 may use hierarchical modulation to transmit the base layer and enhancement layer on the same carrier or subcarriers but with different transmission characteristics resulting in different reliability. In other words, the base layer is transmitted via more reliable portions of a modulated signal, while the enhancement layer is transmitted via less reliable portions of the modulated signal. For example, the base layer and enhancement layer may be transmitted with different PERs such that the base layer is more reliably received. In some aspects, encoding device 12 may be equipped for two-way communication, and thus may include both transmit and receive components and be capable of encoding and decoding multimedia data.

The foregoing techniques may be implemented individually, or two or more of such techniques, or all of such techniques, may be implemented together in encoding device 12. The components in encoding device 12 are exemplary of those applicable to implement the techniques described herein. Encoding device 12, however, may include many other components, if desired, as well as fewer components that combine the functionality of one or more of the modules described above. For ease of illustration, however, such components are not shown in FIG. 2.

The components in encoding device 12 may be implemented as one or more processors, digital signal processors, application specific integrated circuits (ASICs), field programmable gate arrays (FPGAs), discrete logic, software, hardware, firmware or any combinations thereof. Depiction of different features as modules is intended to highlight different functional aspects of encoding device 12 and does not necessarily imply that such modules must be realized by separate hardware or software components. Rather, functionality associated with one or more modules may be integrated within common or separate hardware or software components. Thus, the disclosure should not be limited to the example of encoding device 12.

FIG. 3 is a block diagram illustrating decoding device 14 in further detail. Decoding device 14 includes a demodulator/receiver 30, a selective decoding module 32 and a reference data analysis module 38. Demodulator/receiver 30 receives the coded sequences of frames via network 16. Like modulator/transmitter 26, demodulator/receiver 30 may include appropriate modem, amplifier, filter, and frequency conversion components to support reception and demodulation of the encoded multimedia sequences from network 16 (FIG. 1). In some aspects, decoding device 14 may be equipped for two-way communication, and thus may include both transmit and receive components and be capable of encoding and decoding multimedia data.

As described above, encoding device 12 may use hierarchical modulation to transmit the encoded sequence of frames in a base layer and an enhancement layer that have different transmission characteristics resulting in different reliability. Thus, in certain circumstances, e.g., when decoding device 14 is far from a transmission tower of network 16, decoding device 14 may receive only the coded frames of the base layer. In other circumstances, e.g., when decoding device 14 is closer to a transmission tower of network 16, decoding device 14 may receive the frames from both the base layer and the enhancement layer.

Selective decoding module 32 decodes the coded frames of the received sequence. In particular, selective decoding module 32 decodes the frames of the base layer and the frames of the enhancement layer, if the enhancement layer is received. In decoding the coded frames, selective decoding module 32 decodes the frames using the redundancies used for encoding the frames. In particular, selective decoding module 32 uses spatial redundancies within the same frame to decode the intra-coded frames. Likewise, selective decoding module 32 uses the temporal redundancies of one or more reference frames to decode the inter-coded frames.

Selective decoding module 32 decodes the coded frames of the sequence in accordance with reference data from reference data analysis module 38. Reference data analysis module 38 identifies the reference data that indicates where the intra-coded and inter-coded frames or blocks in the received encoded multimedia sequence are located. Additionally, reference data analysis module 38 may identify the reference data that indicates the location of reference frames for the inter-coded frames. Selective decoding module 32 uses the identified reference frames, if available, to decode the inter-coded frames.

As described above, the enhancement layer includes at least one reference frame that was moved from the base layer to balance the size of the base layer and the enhancement layer. When the enhancement layer is received, selective decoding module 32 decodes at least one frame of the base layer using data of the reference frame in the enhancement layer, if necessary. When the enhancement layer is not received, however, selective decoding module 32 does not have the data from the reference frame in the enhancement layer to successfully decode the frame of the base layer. In certain aspects, selective decoding module 32 may decode a CSF that corresponds with the frame that includes references to the missing reference frame of the enhancement layer. In another example, the frame that references the missing reference frame may be encoded with reference to multiple reference frames, and selective decoding module 32 may decode the frame that references the missing reference frame using only the other reference frames. Otherwise, an error correction module (not shown) may use one or more error correction algorithms to try to correct the errors.

Selective decoding module 32 combines the base layer and enhancement layer multimedia data for a given frame or macroblock when the enhancement layer data is available, i.e., when enhancement layer data has been successfully received. Thus, when both the base layer and the enhancement layer are received, selective decoding module 32 combines the layers to provide a higher quality than when just the base layer is received.

The foregoing techniques may be implemented individually, or two or more of such techniques, or all of such techniques, may be implemented together in decoding device 14. The components in decoding device 14 are exemplary of those applicable to implement the techniques described herein. Decoding device 14, however, may include many other components, if desired, as well as fewer components that combine the functionality of one or more of the modules described above. In addition, decoding device 14 may include appropriate modulation, demodulation, frequency conversion, filtering, and amplifier components for transmission and reception of encoded video, including radio frequency (RF) wireless components and antennas, as applicable. For ease of illustration, however, such components are not shown in FIG. 3.

The components in decoding device 14 may be implemented as one or more processors, digital signal processors, ASICs, FPGAs, discrete logic, software, hardware, firmware or any combinations thereof. Depiction of different features as modules is intended to highlight different functional aspects of decoding device 14 and does not necessarily imply that such modules must be realized by separate hardware or software components. Rather, functionality associated with one or more modules may be integrated within common or separate hardware or software components. Thus, the disclosure should not be limited to the example of decoding device 14.

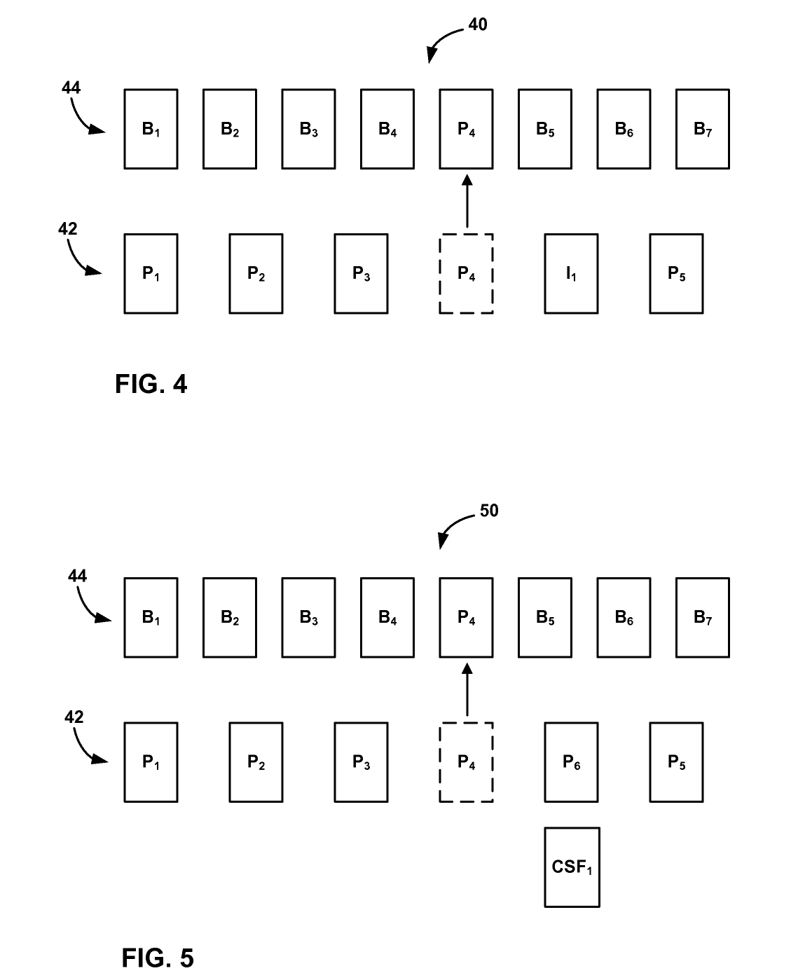

FIG. 4 is a diagram illustrating a portion of an exemplary encoded multimedia sequence 40. Encoded sequence 40 shown in FIG. 4 may correspond to a channel of multimedia data. As an example, encoded sequence 40 may correspond to ESPN, FOX, MSNBC or another television channel. Although the example illustrated in FIG. 4 shows an encoded sequence 40 for only one channel, the techniques of this disclosure are applicable to any number of encoded sequences for any number of channels.

Encoded sequence 40 includes a plurality of coded frames. The coded frames represent compressed versions of respective input frames encoded by various inter-coding or intra-coding techniques. In the example of FIG. 4, encoded sequence 40 includes an I frame I₁, P frames P₁-P₅ and B frames B₁-B₇. Frames I₁ and P₁-P₅ are reference frames. In other words, at least one other frame of encoded sequence 40 has a reference to at least one block of data in each of frames I₁ and P₁-P₅. As an example, frame P₄ may be a reference frame for frames B₄ and B₅. Frames B₁-B₇, on the other hand, are non-reference frames, i.e., no other frames have a reference to any block data of frames B₁-B₇. Although in the example described with reference to FIG. 4 all P frames and I frames are reference frames and all the B frames are non-reference frames, one or more P or I frames may be non-reference frames and one or more B frames may be reference frames.

As described above, allocation module 22 allocates the coded frames between a base layer bitstream 42 and an enhancement layer bitstream 44. Although only one enhancement layer is shown in the example of FIG. 4, the techniques described herein may be used to distribute frames from the base layer to more than one enhancement layer or between enhancement layers. Base layer bitstream 42 initially includes the reference frames I₁ and P₁-P₅. Enhancement layer bitstream 44 initially includes the non-reference frames B₁-B₇. The frame that is illustrated with a dashed line, i.e., reference frame P₄, indicates the initial location of the frame. Although the initial allocation of frames illustrated in FIG. 4 is such that base layer 42 includes all reference frames and enhancement layer 44 includes all non-reference frames, allocation module 22 may initially assign one or more non-reference frames (e.g., one of frames B₁-B₇ in the example of FIG. 4) to base layer 42.

As described above, allocation module 22 may analyze the allocation of the frames between base layer 42 and enhancement layer 44 and reallocate one or more frames based on the analysis. For example, when enhancement layer 44 contains substantially less bits than base layer 42, allocation module 22 may reallocate one or more of the frames from base layer 42 to enhancement layer 44. Specifically, allocation module 22 may reallocate one or more frames when the number of bits in base layer 42 exceeds the number of bits in enhancement layer 44 by a threshold. Initially, allocation module may reassign any non-reference frames that are located in base layer 42 to enhancement layer 44. In the example of FIG. 4, no non-reference frames are initially assigned to base layer 42. Therefore, allocation module 22 selects at least one of the reference frames to move from base layer 42 to enhancement layer 44.

As shown in FIG. 4, allocation module moves reference frame P₄ from base layer 42 to enhancement layer 44. Reference frame P₄ is temporally located immediately prior to an intra-coded frame, i.e., frame I₁. Since intra-coded (I) frames are coded without reference to any other temporally located frames, moving a reference frame immediately prior to the intra-coded frame does not adversely affect the decoding of the subsequent frame, i.e., frame I₁. Moving reference frame P₄ may, however, result in a slightly slower frame rate at decoding device 14 and therefore produce some slight artifacts in the decoded multimedia sequence 40 when enhancement layer 44 is not received. As described above, reference frame P₄ may serve as a reference frame for non-reference frames B₄ and B₅. Reference frame P₄ may continue to serve as a reference frame to those frames because reference frame P₄ will likely be received if non-reference frames B₄ and B₅, which include references to frame P₄, are received.

Encoded sequence 40 illustrated in FIG. 4 is for exemplary purposes only. As described above, encoded sequence 40 may include different arrangements and types of frames. For example, encoded sequences may include different arrangements of reference and non-reference frames. Moreover, any of the reference frames temporally located prior to and near frame I₁ may be moved from base layer 42 to enhancement layer 44. In other cases, for example, one of frames P₂ or P₃ may be moved from base layer 42 to enhancement layer 44. It may, however, be advantageous to move the reference frame that is located closest to the frame I₁ first, i.e., move P₃ to the enhancement layer before moving P₂ to the enhancement layer.

FIG. 5 is a diagram illustrating a portion of another exemplary encoded multimedia sequence 50. Encoded multimedia sequence 50 conforms substantially to encoded multimedia sequence 40 of FIG. 4, except that encoded multimedia sequence 50 does not include an I frame. Instead, frame I₁ of FIG. 4 is replaced with another P frame, i.e., frame P₆. Unlike frame I₁, frame P₆ is not an intra-coded frame, but instead an inter-coded frame that includes at least one reference to frame P₄.

Encoded multimedia sequence 50 also includes a channel switch frame (CSF₁). In this example, CSF₁ is an intra-coded version of at least a portion of a respective input frame. In other words, CSF₁ is coded without reference to other frames, and is therefore independently decodable. In certain aspects, CSF₁ may be encoded at a lower quality than other frames of encoded sequence 50. Moreover, CSF₁ may be temporally co-located with a corresponding one of the inter-coded frames in the sense that the temporal position of CSF₁ within the sequence corresponds to the temporal position of the corresponding inter-coded frame in the same multimedia sequence. In the example illustrated in FIG. 5, CSF₁ is co-located with frame P₆. In this case, CSF₁ may be viewed as a second, intra-coded version of at least a portion of the multimedia data coded in corresponding frame P₆.

In certain aspects, decoding device 14 may selectively decode encoded multimedia sequence 50 depending on whether or not enhancement layer 44 is received. In particular, decoding device 14 may decode frame P₆ using frame P₄ as its reference frame when enhancement layer 44 is received. Thus, frame P₆ located in base layer 42 references a frame in the enhancement layer 44. If enhancement layer 44 is not received by decoding device 14, however, decoding device 14 may decode CSF₁ instead of frame P₆. Since CSF₁ is an intra-coded frame, moving reference frame P₄ to enhancement layer 44 does not affect the decoding of the subsequent frame.

Encoded sequence 50 illustrated in FIG. 5 is for exemplary purposes only. As described above, encoded sequence 50 may include different arrangements and types of frames. For example, encoded sequences may include different arrangements of reference and non-reference frames. Moreover, any of the reference frames temporally located prior to and near CSF₁ may be moved from base layer 42 to enhancement layer 44. For example, frame P₆, i.e., the frame that corresponds to the temporal position of the CSF₁, may be moved to enhancement layer bitstream 44. In other cases, other reference frames such as frames P₂ or P₃ may be moved from base layer 42 to enhancement layer 44. In these cases, if enhancement layer 44 is not received by decoding device 14, decoding device 14 may decode the subsequent CSF, i.e., CSF₁.

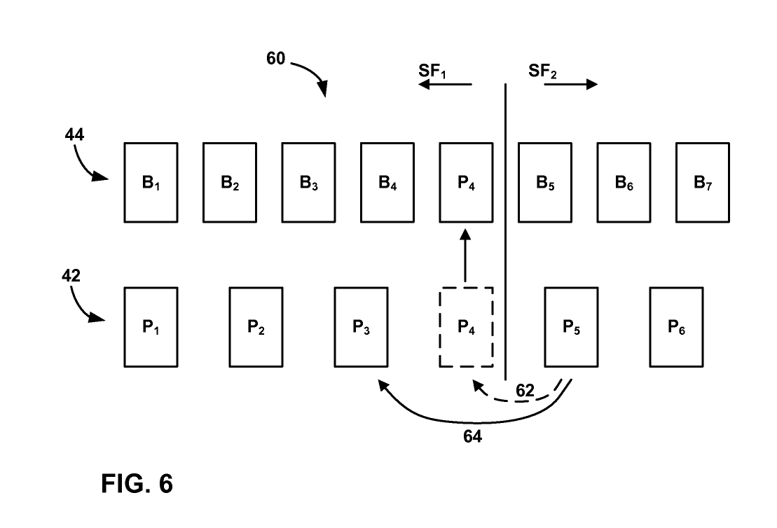

FIG. 6 is a diagram illustrating a portion of another exemplary encoded multimedia sequence 60. Encoded multimedia sequence 60 conforms substantially to encoded multimedia sequences 40 and 50 of FIGS. 4 and 5, respectively, except that encoded multimedia sequence 60 does not include an intra-coded frame, i.e., an I frame or a CSF. Instead, the portion of multimedia sequence 60 illustrated in FIG. 6 includes a base layer 42 and an enhancement layer 44 that includes all inter-coded frames.

The portion of multimedia sequence 60 includes a portion of two segments of data, e.g., superframes SF₁ and SF₂. Superframe SF₁ includes at least frames P₁-P₄ and frames B₁-B₄. Superframe SF₂ includes at least frames P₅ and P₆ as well as frames B₅-B₇. Superframes SF₁ and SF₂ may, however, include more or fewer frames. Additionally, superframes SF₁ and SF₂ may include one or more intra-coded frames (e.g., I frames or CSFs).

As illustrated in FIG. 6, the first frame of superframe SF₂ (i.e., P₅) references the last frame of superframe SF₁ (i.e., P₄) as represented by arrow 62. In other words, encoding module 20 encodes one or more blocks of frame P₅ using temporal redundancies in frame P₄. In accordance with the techniques of this disclosure, allocation module 22 may reassign reference frame P₄ from base layer 42 to enhancement layer 44 to balance the sizes of the layers.

In some cases, encoding device 12 may adjust the forward reference of frame P₅ upon moving frame P₄ from base layer 42 to enhancement layer 44. In certain aspects, encoding module 20 may re-encode frame P₅ with reference to another one of the frames of base layer 42. In the illustrated example, encoding module 20 may re-encode frame P₅ using temporal redundancies in frame P₃, as represented by arrow 64. In other aspects, encoding module 20 may initially encode frame P₅ with reference to more than one temporally prior frame, i.e., frame P₃ and P₄. In this case, encoding module 20 may not re-encode frame P₅, but instead eliminate the reference to P₄.

In other cases, encoding device 12 may not adjust the forward references of frame P₅. Instead, encoding device 12 may leave the reference to P₄ even though P₄ is located in enhancement layer 44. In this case, decoding device 14 may selectively decode the received sequence based on whether enhancement layer 44 is received. When enhancement layer 44 is received, decoding device 14 decodes frame P₅ with reference to frame P₄ in the enhancement layer. When enhancement layer 44 is not received, however, decoding device 14 uses one or more error correction techniques to reconstruct frame P₅ or waits for an intra-coded frame.

Encoded sequence 60 illustrated in FIG. 6 is for exemplary purposes only. As described above, encoded sequence 60 may include different arrangements and types of frames. For example, encoded sequences may include different arrangements of reference and non-reference frames. Moreover, although in the example illustrated in FIG. 6 the last reference frame of superframe SF₁ is reallocated to enhancement layer 44, any of the reference frames may be moved from base layer 42 to enhancement layer 44.

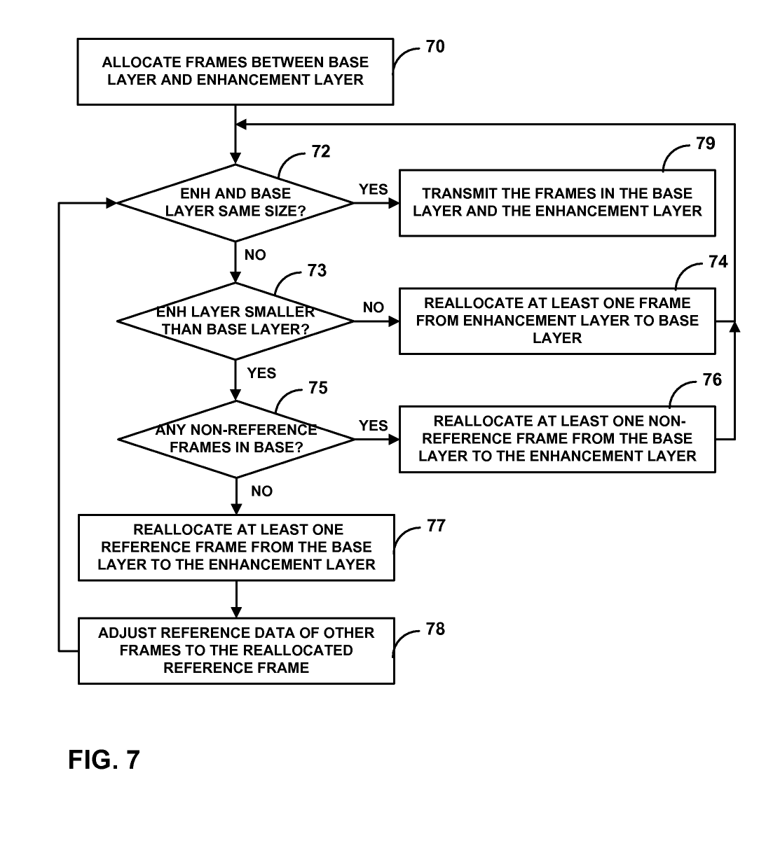

FIG. 7 is a flow diagram illustrating exemplary operation of an encoding device, such as encoding device 12, reallocating one or more reference frames in accordance with the techniques of this disclosure. Initially, allocation module 22 allocates the encoded frames between a base layer bitstream and at least one enhancement layer bitstream (70). In certain aspects, allocation module 22 allocates the frames based on whether the frames are used as reference frames. Allocation module 22 may, for example, initially assign reference frames to the base layer and assign non-reference frames to the enhancement layer. Alternatively, allocation module 22 may use an initial allocation scheme in which one or more non-reference frames are initially assigned to the base layer.

Allocation module 22 analyzes the allocation of the frames between the base layer and the enhancement layer to determine whether the base layer and the enhancement layer are substantially the same size (72). When the enhancement layer and the base layer are not substantially same size, allocation module 22 determines whether the enhancement layer is smaller than the base layer (73) by a predetermined margin or threshold. When the enhancement layer is larger than the base layer by a predetermined threshold (i.e., the enhancement layer includes more bits), allocation module 22 reallocates at least one frame from the enhancement layer to the base layer (74). Allocation module 22 may first reallocate one or more reference frames, if there are any reference frames initially allocated to the enhancement layer. Otherwise, allocation module 22 may reallocate non-reference frames starting with non-reference I frames and non-reference P frames.

When the enhancement layer is smaller than the base layer by a predetermined threshold (i.e., the base layer includes more bits), allocation module 22 determines whether there are any non-reference frames in the base layer (75). When there are non-reference frames in the base layer, allocation module 22 reallocates a non-reference frame from the base layer to the enhancement layer (76). By moving non-reference frames to the enhancement layer, there is no effect on the decoding of subsequent frames when the enhancement layer is not received by decoding device 14.

If there are no non-reference frames in the base layer, allocation module 22 reallocates at least one reference frame from the base layer to the enhancement layer (77). In certain aspects, allocation module 22 may move a reference frame that is temporally located prior to and near an intra-coded frame, i.e., an I frame or a channel switch frame (CSF). For example, allocation module 22 may move the reference frame that is temporally located immediately prior to the intra-coded frame. Since intra-coded frames are coded without reference to any other temporally located frames, moving the reference frame temporally located immediately prior to the intra-coded frame does not affect the decoding of the subsequent frame. In other aspects, allocation module 22 may move a reference frame located near the end of a superframe or other segment of data.

Encoding device 12 may adjust reference data of one or more frames that include references to the reallocated reference frame (78). For example, allocation module 22 may request that encoding module 20 re-encode one or more frames of the base layer that rely on the reassigned reference frame to include a reference to a different frame in the base layer. Alternatively, if the frame that relies on the reassigned frame is coded using multiple reference frames, reference data generator 24 may simply remove the reference to the reference frame that was reassigned to the enhancement layer. Encoding device 12 may, however, not adjust any reference data, and instead simply leave the references to the reassigned reference frame. In this case, decoding device 14 may decode the data normally if the enhancement layer with the reference frame is received. If the enhancement layer that includes the reference frame is not received, decoding device 14 may perform error correction to account for the missing data of the reference frame. In this manner, allocation module 22 balances the sizes of the base layer and the enhancement layer.

When the base layer and the enhancement layer are substantially the same size, encoding device 12 transmits the layers of frames (79). Modulator/transmitter 26 may use hierarchical modulation to transmit the base layer and enhancement layer on the same carrier or subcarriers but with different transmission characteristics resulting in different reliability. For example, the base layer and enhancement layer may be transmitted with different PERs such that the base layer is more reliably received.

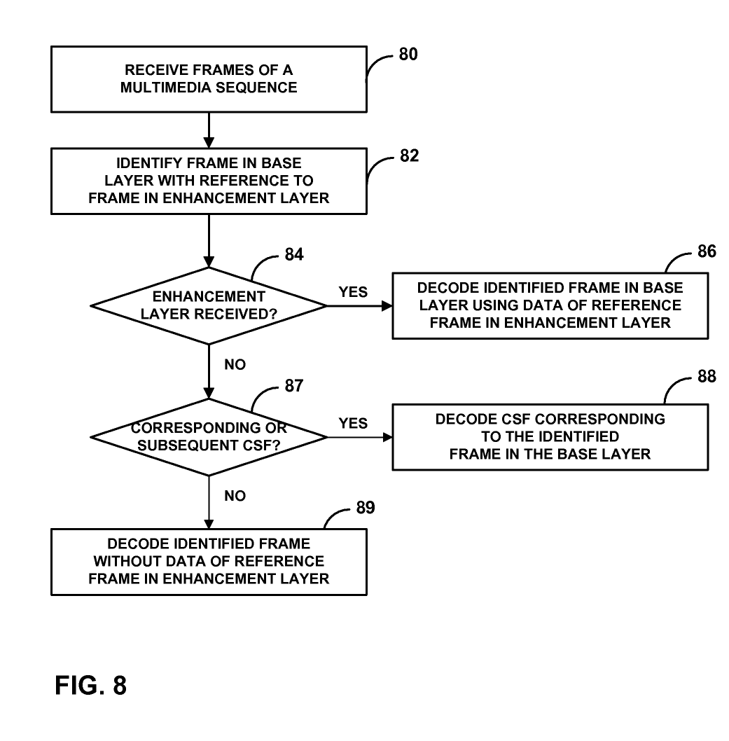

FIG. 8 is a flow diagram illustrating exemplary operation of a decoding device, such as decoding device 14, selectively decoding frames of a base layer. Decoding device 14 receives frames of a multimedia sequence (80). As described above, decoding device 14 may receive only the coded frames of the base layer or the coded frames of both the base layer and the enhancement layer depending on the location of decoding device 14 relative to network 16 (FIG. 1).

Decoding device 14 identifies frames in the base layer with reference to content of a frame in the enhancement layer (82). Decoding device 14 may analyze the reference data received to identify the frames of interest. Decoding device 14 determines whether the enhancement layer is received (84). When the enhancement layer is received, decoding device 14 decodes the identified frame in the base layer using data of the corresponding reference frame in the enhancement layer (86).

When the enhancement layer is not received, decoding device 14 determines whether there is a CSF corresponding to or subsequent to the identified frame (87). When there is a CSF corresponding to or subsequent to the identified frame, decoding device 14 decodes the CSF instead of decoding the identified frame (88). When there is no CSF corresponding to the identified frame, decoding device 14 decodes the frame without data from the reference frame in the enhancement layer (89). In certain aspects, decoding device 14 may decode the identified frame using data of other reference frames, e.g., when the identified frame includes references to more than one frame. In other aspects, decoding device 14 may use one or more error correction techniques to reconstruct the identified frame.

Based on the teachings described herein, it should be apparent that an aspect disclosed herein may be implemented independently of any other aspects and that two or more of these aspects may be combined in various ways. The techniques described herein may be implemented in hardware, software, firmware, or any combination thereof. If implemented in hardware, the techniques may be realized using digital hardware, analog hardware or a combination thereof. If implemented in software, the techniques may be realized at least in part by a computer-program product that includes a computer readable medium on which one or more instructions or code is stored.

By way of example, and not limitation, such computer-readable media can comprise RAM, such as synchronous dynamic random access memory (SDRAM), read-only memory (ROM), non-volatile random access memory (NVRAM), ROM, electrically erasable programmable read-only memory (EEPROM), erasable programmable read-only memory (EPROM), FLASH memory, CD-ROM or other optical disk storage, magnetic disk storage or other magnetic storage devices, or any other tangible medium that can be used to carry or store desired program code in the form of instructions or data structures and that can be accessed by a computer.

The instructions or code associated with a computer-readable medium of the computer program product may be executed by a computer, e.g., by one or more processors, such as one or more digital signal processors (DSPs), general purpose microprocessors, ASICs, FPGAs, or other equivalent integrated or discrete logic circuitry.

A number of aspects and examples have been described. However, various modifications to these examples are possible, and the principles presented herein may be applied to other aspects as well. These and other aspects are within the scope of the following claims.

What is claimed is:

1. A method for processing multimedia data, the method comprising:
coding a plurality of frames of multimedia data, wherein the plurality of frames include one or more reference frames; and
allocating each of the plurality of frames between a base layer bitstream and at least one enhancement layer bitstream such that at least one of the one or more reference frames is allocated to the enhancement layer bitstream.

2. The method of claim 1, wherein allocating the frames comprises allocating the at least one of the one or more reference frames temporally located immediately prior to an intra-coded one of the frames to the enhancement layer bitstream.

3. The method of claim 2, wherein allocating the at least one of the one or more reference frames temporally located immediately prior to the intra-coded one of the frames comprises allocating the at least one of the one or more reference frames temporally located immediately prior to a channel switch frame to the enhancement layer bitstream.

4. The method of claim 1, wherein allocating the frames comprises allocating the at least one of the one or more reference frames corresponding to a channel switch frame to the enhancement layer bitstream.

5. The method of claim 1, further comprising grouping at least some of the frames to form a segment of data, wherein allocating the frames comprises allocating the at least one of the one or more reference frames located near an end of the segment of data to the enhancement layer bitstream.

6. The method of claim 1, wherein allocating the frames comprises:
analyzing an initial allocation of the frames between the base layer bitstream and the enhancement layer bitstream; and
reallocating the at least one of the one or more reference frames from the base layer bitstream to the enhancement layer bitstream based on the analysis.

7. The method of claim 6, wherein reallocating the at least one of the one or more reference frames comprises reallocating the at least one of the one or more reference frames from the base layer bitstream to the enhancement layer bitstream when there are no non-reference frames in the base layer bitstream.

8. The method of claim 6, wherein:
analyzing the initial allocation comprises comparing a size of the enhancement layer bitstream to a size of the base layer bitstream; and
reallocating the at least one of the one or more reference frames comprises reallocating the at least one of the one or more reference frames from the base layer bitstream to the enhancement layer bitstream when a size of the enhancement layer bitstream is less than a size of the base layer bitstream by a threshold value.

9. The method of claim 6, further comprising reallocating frames from the base layer bitstream to the enhancement layer bitstream until a difference between a size of the base layer and a size of the enhancement layer is minimized.

10. The method of claim 1, further comprising removing a reference of a subsequent one of the frames in the base layer bitstream to the at least one of the one or more reference frames allocated to the enhancement layer bitstream.

11. The method of claim 10, wherein removing the reference of the subsequent one of the frames to the at least one of the one or more reference frames comprises re-encoding the subsequent one of the frames in the base layer bitstream to exclude the reference to the at least one of the one or more reference frames allocated to the enhancement layer bitstream.

12. The method of claim 1, wherein allocating the at least one of the one or more reference frames to the enhancement layer bitstream comprises allocating one of a predictive (P) frame and an intra (I) frame to the enhancement layer bitstream.

13. The method of claim 1, further comprising:
transmitting the base layer via a more reliable portion of a modulated signal; and
transmitting the enhancement layer via a less reliable portion of the modulated signal.

14. An apparatus for processing multimedia data, the apparatus comprising:
an encoding module that codes a plurality of frames of multimedia data, wherein the plurality of frames include one or more reference frames; and
an allocation module that allocates each of the plurality frames between a base layer bitstream and at least one enhancement layer bitstream such that at least one of the one or more reference frames is allocated to the enhancement layer bitstream.

15. The apparatus of claim 14, wherein the allocation module allocates the at least one of the one or more reference frames temporally located immediately prior to an intra-coded one of the frames to the enhancement layer bitstream.

16. The apparatus of claim 15, wherein the allocation module allocates the at least one of the one or more reference frames temporally located immediately prior to a channel switch frame to the enhancement layer bitstream.

17. The apparatus of claim 14, wherein the allocation module allocates the at least one of the one or more reference frames corresponding to a channel switch frame to the enhancement layer bitstream.

18. The apparatus of claim 14, wherein:
the encoding module groups at least some of the frames to form a segment of data, and
the allocation module allocates the at least one of the one or more reference frames located near an end of the segment of data to the enhancement layer bitstream.

19. The apparatus of claim 14, wherein the allocation module analyzes an initial allocation of the frames between the base layer bitstream and the enhancement layer bitstream and reallocates the at least one of the one or more reference frames from the base layer bitstream to the enhancement layer bitstream based on the analysis.

20. The apparatus of claim 19, wherein the allocation module reallocates the at least one of the one or more reference frames from the base layer bitstream to the enhancement layer bitstream when there are no non-reference frames in the base layer bitstream.

21. The apparatus of claim 19, wherein the allocation module compares a size of the enhancement layer bitstream to a size of the base layer bitstream and reallocates the at least one of the one or more reference frames from the base layer bitstream to the enhancement layer bitstream when a size of the enhancement layer bitstream is less than a size of the base layer bitstream by a threshold value.

22. The apparatus of claim 19, wherein the allocation module reallocating frames from the base layer bitstream to the enhancement layer bitstream until a difference between a size of the base layer and a size of the enhancement layer is minimized.

23. The apparatus of claim 14, further comprising a reference data generator that removes a reference of a subsequent one of the frames in the base layer bitstream to the at least one of the one or more reference frames allocated to the enhancement layer bitstream.

24. The apparatus of claim 23, wherein the encoding module re-encodes the subsequent frames in the base layer bitstream to exclude the reference to the at least one of the one or more reference frames allocated to the enhancement layer bitstream.

25. The apparatus of claim 14, wherein the allocation module allocates one of a predictive (P) frame and an intra (I) frame to the enhancement layer bitstream.

26. The apparatus of claim 14, further comprising a modulator/transmitter that transmits that base layer via a more reliable portion of a modulated signal and transmits the enhancement layer via a less reliable portion of the modulated signal.

27. An apparatus for processing multimedia data, the apparatus comprising:
means for coding a plurality of frames of multimedia data, wherein the plurality of frames include one or more reference frames; and
means for allocating each of the plurality of frames between a base layer bitstream and at least one enhancement layer bitstream such that at least one of the one or more reference frames is allocated to the enhancement layer bitstream.

28. The apparatus of claim 27, wherein the allocating means allocate the at least one of the one or more reference frames temporally located immediately prior to an intra-coded one of the frames to the enhancement layer bitstream.

29. The apparatus of claim 28, wherein the allocating means allocate the at least one of the one or more reference frames temporally located immediately prior to a channel switch frame to the enhancement layer bitstream.

30. The apparatus of claim 27, wherein the allocating means allocates the at least one of the one or more reference frames corresponding to a channel switch frame to the enhancement layer bitstream.

31. The apparatus of claim 27, further comprising means for grouping at least some of the frames to form a segment of data, wherein the allocating means allocate the at least one of the one or more reference frames located near an end of the segment of data to the enhancement layer bitstream.

32. The apparatus of claim 27, wherein the allocating means analyze an initial allocation of the frames between the base layer bitstream and the enhancement layer bitstream and reallocate the at least one of the one or more reference frames from the base layer bitstream to the enhancement layer bitstream based on the analysis.

33. The apparatus of claim 32, wherein the allocating means reallocate the at least one of the one or more reference frames from the base layer bitstream to the enhancement layer bitstream when there are no non-reference frames in the base layer bitstream.

34. The apparatus of claim 32, wherein the allocating means compares a size of the enhancement layer bitstream to a size of the base layer bitstream and reallocates the at least one of the one or more reference frames from the base layer bitstream to the enhancement layer bitstream when a size of the enhancement layer bitstream is less than a size of the base layer bitstream by a threshold value.

35. The apparatus of claim 32, wherein the allocation module reallocates frames from the base layer bitstream to the enhancement layer bitstream until a difference between a size of the base layer and a size of the enhancement layer is minimized.

36. The apparatus of claim 27, further comprising means for removing a reference of a subsequent one of the frames in the base layer bitstream to the at least one of the one or more reference frames allocated to the enhancement layer bitstream.

37. The apparatus of claim 36, wherein the encoding means re-encodes the subsequent frames in the base layer bitstream to exclude the reference to the at least one of the one or more reference frames allocated to the enhancement layer bitstream.

38. The apparatus of claim 27, wherein the allocating means allocates one of a predictive (P) frame and an intra (I) frame to the enhancement layer bitstream.

39. The apparatus of claim 27, further comprising means for transmitting the base layer via a more reliable portion of a modulated signal and the enhancement layer via a less reliable portion of the modulated signal.

40. A computer-program product for processing multimedia data comprising a computer readable medium having instructions thereon, the instructions comprising:
code for encoding a plurality of frames of multimedia data, wherein the plurality of frames include one or more reference frames; and
code for allocating each of the plurality of frames between a base layer bitstream and at least one enhancement layer bitstream such that at least one of the one or more reference frames is allocated to the enhancement layer bitstream.

41. The computer-program product of claim 40, wherein code for allocating the frames comprises code for allocating the at least one of the one or more reference frames temporally located immediately prior to an intra-coded one of the frames to the enhancement layer bitstream.

42. The computer-program product of claim 41, wherein code for allocating the at least one of the one or more reference frames temporally located immediately prior to the intra-coded one of the frames comprises code for allocating the at least one of the one or more reference frames temporally located immediately prior to a channel switch frame to the enhancement layer bitstream.

43. The computer-program product of claim 40, wherein code for allocating the frames comprises code for allocating the at least one of the one or more reference frames corresponding to a channel switch frame to the enhancement layer bitstream.

44. The computer-program product of claim 40, further comprising code for grouping at least some of the frames to form a segment of data, wherein code for allocating the frames comprises code for allocating the at least one of the one or more reference frames located near an end of the segment of data to the enhancement layer bitstream.

45. The computer-program product of claim 40, wherein code for allocating the frames comprises:
code for analyzing an initial allocation of the frames between the base layer bitstream and the enhancement layer bitstream; and
code for reallocating the at least one of the one or more reference frames from the base layer bitstream to the enhancement layer bitstream based on the analysis.

46. The computer-program product of claim 45, wherein code for reallocating the at least one of the one or more reference frames comprises code for reallocating the at least one of the one or more reference frames from the base layer bitstream to the enhancement layer bitstream when there are no non-reference frames in the base layer bitstream.

47. The computer-program product of claim 45, wherein:
code for analyzing the initial allocation comprises code for comparing a size of the enhancement layer bitstream to a size of the base layer bitstream; and
code for reallocating the at least one of the one or more reference frames comprises code for reallocating the at least one of the one or more reference frames from the base layer bitstream to the enhancement layer bitstream when a size of the enhancement layer bitstream is less than a size of the base layer bitstream by a threshold value.

48. The computer-program product of claim 45, further comprising code for reallocating frames from the base layer bitstream to the enhancement layer bitstream until a difference between a size of the base layer and a size of the enhancement layer is minimized.

49. The computer-program product of claim 40, further comprising code for removing a reference of a subsequent one of the frames in the base layer bitstream to the at least one of the one or more reference frames allocated to the enhancement layer bitstream.

50. The computer-program product of claim 49, wherein code for removing the reference of the subsequent one of the frames to the at least one of the one or more reference frames comprises code for re-encoding the subsequent one of the frames in the base layer bitstream to exclude the reference to the at least one of the one or more reference frames allocated to the enhancement layer bitstream.

51. The computer-program product of claim 40, wherein code for allocating the at least one of the one or more reference frames to the enhancement layer bitstream comprises code for allocating one of a predictive (P) frame and an intra (I) frame to the enhancement layer bitstream.

52. The computer-program product of claim 40, further comprising code for transmitting the base layer via a more reliable portion of a modulated signal and the enhancement layer via a less reliable portion of the modulated signal.

53. A method for processing multimedia data, the method comprising:
identifying at least one frame of a base layer bitstream of a scalable coding scheme that references at least a portion of a reference frame of an enhancement layer bitstream; and
decoding the identified frame of the base layer bitstream using the portion of the reference frame of the enhancement layer bitstream referenced by the identified frame of the base layer bitstream when the enhancement layer bitstream is received.

54. The method of claim 53, further comprising decoding a channel switch frame that corresponds to the identified frame of the base layer bitstream when the enhancement layer bitstream is not received.

55. The method of claim 53, further comprising decoding a channel switch frame that is subsequent to the identified frame of the base layer bitstream when the enhancement layer bitstream is not received.

56. The method of claim 53, wherein the identified frame of the base layer bitstream is coded with reference to the portion of the reference frame of the enhancement layer bitstream and with reference to at least one reference frame in the base layer bitstream, the method further comprising decoding the identified frame of the base layer bitstream using data of the at least one reference frame in the base layer bitstream when the enhancement layer bitstream is not received.

57. The method of claim 53, further comprising utilizing one or more error correction algorithms to reconstruct the identified frame of base layer bitstream when the enhancement layer bitstream is not received.

58. An apparatus for processing multimedia data, the apparatus comprising:
a reference data analysis module that identifies at least one frame of a base layer bitstream of a scalable coding scheme that references at least a portion of a reference frame of an enhancement layer bitstream; and
a decoding module that decodes the identified frame of the base layer bitstream using the portion of the reference frame of the enhancement layer bitstream referenced by the identified frame of the base layer bitstream when the enhancement layer bitstream is received.

59. The apparatus of claim 58, wherein the decoding module decodes a channel switch frame that corresponds to the identified frame of the base layer bitstream when the enhancement layer bitstream is not received.

60. The apparatus of claim 58, wherein the decoding module decodes a channel switch frame that is subsequent to the identified frame of the base layer bitstream when the enhancement layer bitstream is not received.

61. The apparatus of claim 58, wherein:
the identified frame of the base layer bitstream is coded with reference to the portion of the reference frame of the enhancement layer bitstream and with reference to least one reference frame in the base layer bitstream, and
the decoding module decodes the identified frame of the base layer bitstream using data of the at least one reference frame in the base layer bitstream when the enhancement layer bitstream is not received.

62. The apparatus of claim 58, wherein the decoding module utilizes one or more error correction algorithms to reconstruct the identified frame of base layer bitstream when the enhancement layer bitstream is not received.

63. An apparatus for processing multimedia data, the apparatus comprising:
means for identifying at least one frame of a base layer bitstream of a scalable coding scheme that references at least a portion of a reference frame of an enhancement layer bitstream; and
means for decoding the identified frame of the base layer bitstream using the portion of the reference frame of the enhancement layer bitstream referenced by the identified frame of the base layer bitstream when the enhancement layer bitstream is received.

64. The apparatus of claim 63, wherein the decoding means decodes a channel switch frame that corresponds to the identified frame of the base layer bitstream when the enhancement layer bitstream is not received.

65. The apparatus of claim 63, wherein the decoding means decodes a channel switch frame that is subsequent to the identified frame of the base layer bitstream when the enhancement layer bitstream is not received.

66. The apparatus of claim 63, wherein:
the identified frame of the base layer bitstream is coded with reference to the portion of the reference frame of the enhancement layer bitstream and with reference to at least one reference frame in the base layer bitstream, and
the decoding means decodes the identified frame of the base layer bitstream using data of the at least one reference frame in the base layer bitstream when the enhancement layer bitstream is not received.

67. The apparatus of claim 63, wherein the decoding means utilizes one or more error correction algorithms to reconstruct the identified frame of base layer bitstream when the enhancement layer bitstream is not received.

68. A computer-program product for processing multimedia data comprising a computer readable medium having instructions thereon, the instructions comprising:
code for identifying at least one frame of a base layer bitstream of a scalable coding scheme that references at least a portion of a reference frame of an enhancement layer bitstream; and
code for decoding the identified frame of the base layer bitstream using the portion of the reference frame of the enhancement layer bitstream referenced by the identified frame of the base layer bitstream when the enhancement layer bitstream is received.

69. The computer-program product of claim 68, further comprising code for decoding a channel switch frame that corresponds to the identified frame of the base layer bitstream when the enhancement layer bitstream is not received.

70. The computer-program product of claim 68, further comprising code for decoding a channel switch frame that is subsequent to the identified frame of the base layer bitstream when the enhancement layer bitstream is not received.

71. The computer-program product of claim 68, wherein the identified frame of the base layer bitstream is coded with reference to the portion of the reference frame of the enhancement layer bitstream and with reference to at least one reference frame in the base layer bitstream, and further comprising code for decoding the identified frame of the base layer bitstream using data of the at least one reference frame in the base layer bitstream when the enhancement layer bitstream is not received.

72. The computer-program product of claim 68, further comprising code for utilizing one or more error correction algorithms to reconstruct the identified frame of base layer bitstream when the enhancement layer bitstream is not received.
